(19) United States
(12) Patent Application Publication
(10) Pub. No.: US 2007/0127012 A1
(43) Pub. Date: Jun. 7, 2007

(54) Rate-based range and geolocation

(75) Inventor: Matthew A. Kornblum, Bradenton, FL (US)

Correspondence Address: Adams Evans P.A., 2180 Two Wachovia Center, 301 S. Tryon Street, Charlotte, NC, 28282, US

(73) Assignee: GYROCAM SYSTEMS, LLC, Sarasota, FL (US)

(21) Appl. No.: 11/295,096

(22) Filed: Dec. 6, 2005

(51) Int. Cl. G01C 1/00

(52) U.S. Cl. 356/139.01; 356/28

(57) ABSTRACT

A rate based method for passively determining the range and geolocation of a target from a moving platform. The method includes the steps of determining a speed of the platform in a direction of travel thereof; acquiring the target along a line from the platform; determining an angle between the direction of travel of the platform and the line; determining a rate of change in the angle; and calculating the range based on the speed, the angle, and the rate of change. The method further includes the step of determining the geolocation based on the geoposition of the platform, the angle, and the range.

### TECHNICAL FIELD AND BACKGROUND OF THE INVENTION

The present invention relates to the field of target range and geolocation. In particular, the invention relates to a rate-based method for passively determining the range and geolocation of a target from a moving platform.

Passively determining the range and geolocation of a target from a moving platform may be accomplished using various methods. One such method is to take measurements from two different positions along a direction of the platform and calculate the range and position of the target relative to the platform using trigonometry. This is referred to as “triangulation.”

This method is shown in FIG. 1. As illustrated, the range and geolocation of a target is determined by measuring, at two different positions separated by a distance, the gimbal angles of a gimbal mounted on an aircraft. The farther apart the two positions are, the better the accuracy. As the aircraft moves from the first position to the second position along a flight path, the gimbal moves to allow the target to be monitored. Thus, movement of the gimbal creates a measured gimbal angle at the first position and a measured gimbal angle at the second position. The measured distance between the two positions and the measured gimbal angles produce a triangle. The angles and sides of the triangle can then be calculated, thereby deriving the range and position to the target.

While this method is commonly used, there are disadvantages associated with this method. For example, in a tactical situation, loitering between the two positions increases the exposure time of the aircraft, thereby increasing risk to the crew. Also, since the measurement positions are not taken simultaneously, the correlations between measurement errors are temporally diluted, thereby reducing precision. Further examples of triangulation are described in U.S. Pat. Nos. 6,806,828 and 6,172,747.

A second method for passively determining the range and geolocation of a target is to determine an intersection of a line of sight with a topographical map of the region. However, this method is susceptible to large geolocation errors. These errors are a result of error magnification based on the slope of the terrain and measuring line of sight elevation angles. Thus, if the terrain slopes away from the line of sight, the errors in target range increase. The errors also increase by the cosecant of the elevation angle, so small errors in gimbal angle readings relate to large errors in range when gimbal elevation angles are small. Additionally, this method requires knowledge of the location and attitude of the gimbal, the relation of the line of sight to the earth, a large database of topographical information, and computing power sufficient to derive the intersection.

Accordingly, there is a need for a method for passively determining the geolocation of a target from a moving platform with minimal exposure time and errors that can be used without a large database of topographical information, or with a topographical map to further reduce errors.

### SUMMARY OF THE INVENTION

Therefore it is an object of the invention to provide a method that can determine the range to a target with reduced exposure time.

It is another object of the invention to provide a method that minimizes targeting errors.

It is another object of the invention to provide a method that can determine the geoposition of a target.

It is another object of the invention to provide a method that can be used in combination with other prior art methods.

These and other objects of the present invention are achieved in the preferred embodiments disclosed below by providing a method of determining a range from a platform to a target. The method includes the steps of determining a speed of the platform in a direction of travel thereof; acquiring the target along a line from the platform; determining an angle between the direction of travel of the platform and the line; determining a rate of change in the angle; and calculating the range based on the speed, the angle, and the rate of change of angle.

According to another preferred embodiment of the invention, the speed, the angle, and the rate of change of angle are determined at a single platform position along the direction of the platform.

According to another preferred embodiment of the invention, the range is defined as:
r=(v/(dθ/dt))*sin θ.

According to another preferred embodiment of the invention, the step of acquiring the target includes acquiring the target visually along a line of sight.

According to another preferred embodiment of the invention, the target is acquired visually using a telescope.

According to another preferred embodiment of the invention, a method of determining a range from a platform to a target includes the steps of providing a platform having a gimbal, an optical unit, a global positioning system aided inertial navigation system, and a computing device. The method further includes the steps of determining a speed of the platform in a direction of travel thereof, acquiring the target in the optical unit along a line of sight from the platform, determining an angle between the direction of travel of the platform and the line of sight, determining a rate of change in the angle, and. calculating the range based on the speed, the angle, and the rate of change.

According to another preferred embodiment of the invention, the method further includes the step of providing the speed, the angle, and the rate of change to the computing device.

According to another preferred embodiment of the invention, the speed of the platform is determined by the global positioning system aided inertial navigation system.

According to another preferred embodiment of the invention, the step of acquiring the target further includes the step of centering the target in the optical unit.

According to another preferred embodiment of the invention, the angle between the line of sight and the direction of travel of the platform is determined from gimbal angles of the gimbal.

According to another preferred embodiment of the invention, a method of determining a range and geolocation from a platform to a target includes the steps of providing a platform having a gimbal, an optical unit, a global positioning system aided inertial navigation system, and a computing device. The method further includes the steps of determining a speed of the platform in a direction of travel thereof, acquiring the target in the optical unit along a line of sight from the platform, determining an angle between the direction of travel of the platform and the line of sight, and determining a rate of change in the angle. Further the method includes the steps of calculating the range based on the speed, the angle, and the rate of change; determining the geolocation of the platform in space; determining gimbal angles relative to earth; and calculating the geolocation of the target based on the geolocation of the platform, the gimbal angles relative to earth, and the range.

According to another preferred embodiment of the invention, the method further includes the step of providing the geolocation of the platform, the gimbal angles relative to earth, and the range to the computing device.

According to another preferred embodiment of the invention, the speed, gimbal angles relative to earth, and geolocation of the platform are determined by the global positioning system (GPS) aided inertial navigation system (INS).

According to another preferred embodiment of the invention, the method further includes the step of correlating the range to a topographical map to increase accuracy.

According to another preferred embodiment of the invention, the optical unit is a telescope.

### BRIEF DESCRIPTION OF THE DRAWINGS

The invention may be best understood by reference to the following description in conjunction with the accompanying drawing figures, in which:

FIG. 1 shows a prior art method for determining the geolocation of a target;

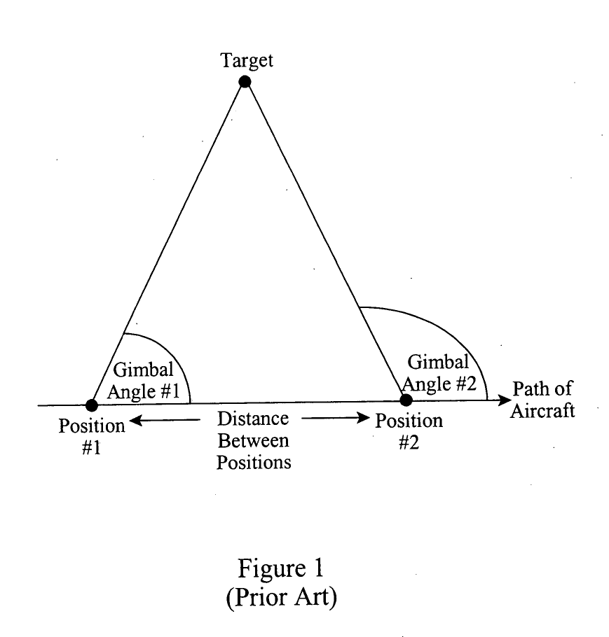

FIG. 2 shows an apparatus according to an embodiment of the invention for determining a range and geolocation of a target;

FIG. 3 shows a method according to an embodiment of the invention for determining a range of a target using the apparatus of FIG. 2; and

FIG. 4 shows a method according to an embodiment of the invention for determining the geolocation of a target using the apparatus of FIG. 2.

### DESCRIPTION OF THE PREFERRED EMBODIMENT AND BEST MODE

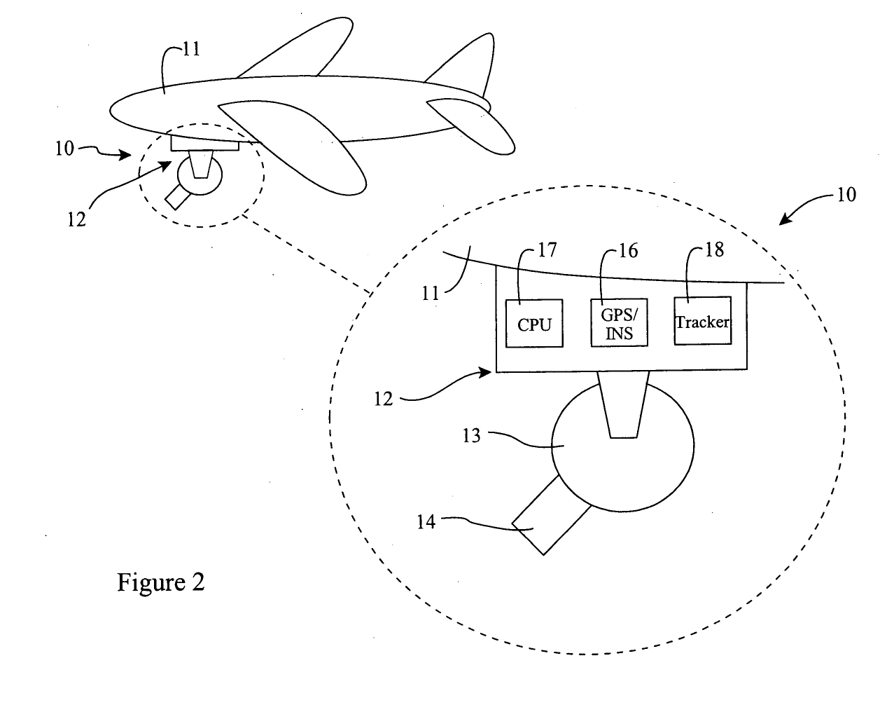

Referring now specifically to the drawings, an apparatus for passively determining the range and geolocation of a target according to an embodiment of the invention is illustrated in FIGS. 2-4 and shown generally at reference numeral 10.

The apparatus 10 includes a gimbal platform 12 mounted to an aircraft 11 to determine a range “r” and geolocation of a target “T”. The gimbal platform 12 is mounted to the aircraft 11 in such a way as to allow a clear view of the target to be identified, and includes a gimbal 13 having an optical unit, such as a telescope 14, a global positioning system (GPS) aided inertial navigation system (INS) 16, and a computing device, such as a central processing unit (CPU) 17, to calculate range, location, and errors in location. The GPS aided INS 16 provides a means for determining the position and velocity of the gimbal platform 12 relative to the earth. Additionally, the GPS aided INS 16 provides a means for determining gimbal angles required to acquire the target T in the telescope 14 and gimbal rate required to hold the target T centered in the telescope 14.

The apparatus 10 further includes a means to view and lock onto the target T. This could be a human being centering the target T in a video monitor displaying the telescope image or an automated tracker 18 performing the same function. Preferably, the tracker 18 is an automated video tracker, such as those produced by Electro-Optical Imaging, Inc. The tracker 18 uses algorithms to recognize a selected set of characteristics of the target T on a video monitor and determine the target T's spatial coordinates. A control loop forces the apparatus 10 to keep the target T in the center of the video monitor.

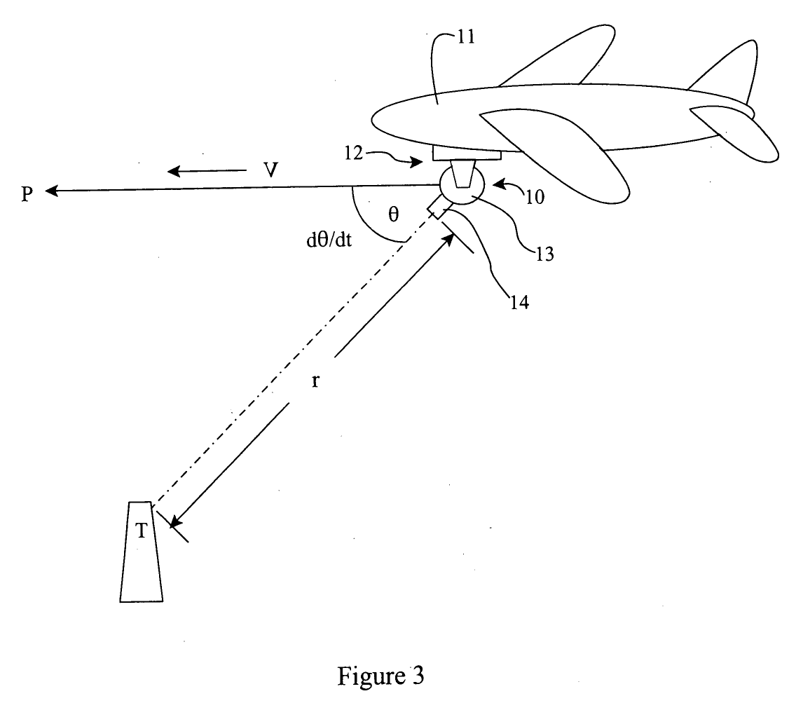

The method of calculating the range r to the target T from a moving platform is illustrated in FIG. 3. The aircraft 11 carrying the gimbal platform 12 follows a flight path “P”. The target T is acquired and centered in the telescope 14, either manually or by automated tracking.

Once the target T is centered, a line of sight angle θ can be calculated from the gimbal angle and the direction of the flight path P. The “gimbal rate” dθ/dt or time rate of change of the gimbal angle is continuously provided to the CPU 17. A velocity “v,” i.e. the speed of the gimbal platform 12 in a direction thereof, and position in space of the gimbal platform 12 are supplied to the CPU 17 from the GPS aided INS 16. All of these values may be taken at a single gimbal position in space and time, thereby eliminating long exposure times and temporal dilution of precision of the triangulation method.

Once these values are known, the range r to the target T may be defined as:
r=(v/(dθ/dt))*sin θ
To further enhance the range accuracy, the gimbal rate dθ/dt may be modified by the earth's rotation rate. This is particularly important when an aircraft is flying east or west because the earth rate sensed by the INS 16 would be higher or lower than the rate relating the aircraft to the target.

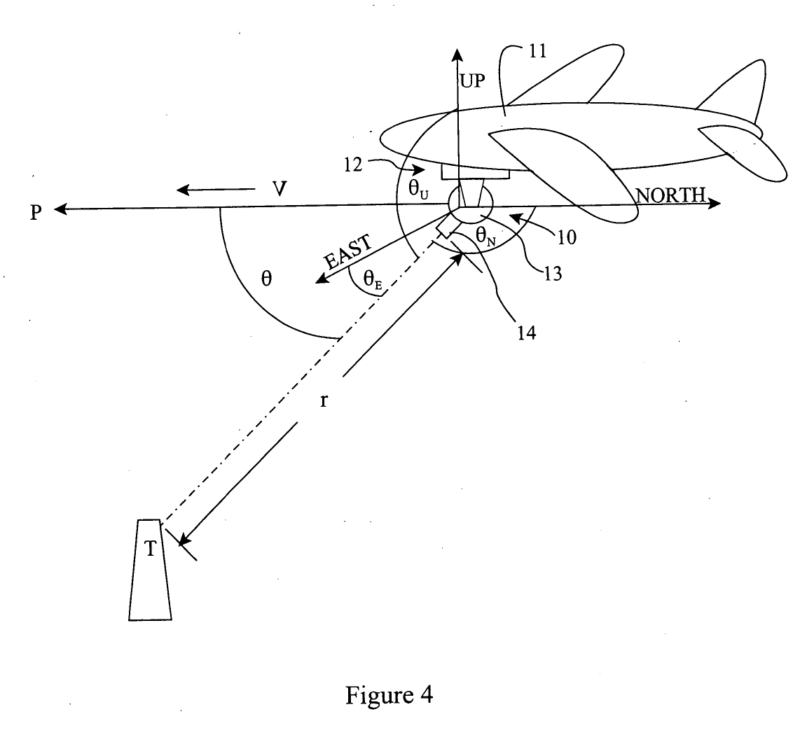

Referring to FIG. 4, once the range r to the target T is known, the geoposition of the target T can be determined. This is done by determining the location of the gimbal 13 in space and using attitude information (gimbal angles relative to earth θ_{E}, θ_{N}, and θ_{U}) from the INS 16 to calculate the line of sight relative to north and down and the range of the target based on gimbal velocity, gimbal rate, and gimbal angles. Once the geoposition of the target T is known, the system can be locked to that target T's location, independent of aircraft speed.

The method described above may also be used in combination with prior art methods, such as with a topographical map, to further improve range and geolocation accuracy. Because the method does not suffer from problems in topographical slope or elevation cosecant angles, the method can be used with the topographical map to improve targeting by correlating rate-based passive ranging to map solutions, thereby reducing errors from both approaches.

A rate-based method for determining the range and geolocation of a target is described above. Various details of the invention may be changed without departing from its scope. Furthermore, the foregoing description of the preferred embodiments of the invention and best mode for practicing the invention are provided for the purpose of illustration only and not for the purpose of limitation.

I claim:

1. A method of determining a range from a platform to a target, comprising the steps of:
(a) determining a speed of the platform in a direction of travel thereof;
(b) acquiring the target along a line from the platform;
(c) determining an angle between the direction of travel of the platform and the line;
(d) determining a rate of change in the angle; and
(e) calculating the range based on the speed, the angle, and the rate of change.

2. The method of claim 1, wherein the speed, the angle, and the rate of change are determined at a single platform position.

3. The method of claim 1, wherein the range is defined as:
r=(v/(dθ/dt))*sin θ.

4. The method of claim 1, wherein the step of acquiring the target includes acquiring the target visually along a line of sight.

5. The method of claim 4, wherein the target is acquired visually by a telescope.

6. A method of determining a range from a platform to a target, comprising the steps of:
(a) providing a platform having a gimbal, an optical unit, a global positioning system (GPS) aided inertial navigation system (INS), and a computing device;
(b) determining a speed of the platform in a direction of travel thereof;
(c) acquiring the target using the optical unit along a line of sight from the platform;
(d) determining an angle between a line defined by the direction of travel of the platform and the line of sight;
(e) determining a rate of change in the angle; and
(f) calculating the range based on the speed, the angle, and the rate of change.

7. The method of claim 6, and further including the step of providing the speed, the angle, and the rate of change to the computing device.

8. The method of claim 6, wherein the speed of the platform is determined by the global positioning system aided inertial navigation system.

9. The method of claim 6, wherein the step of acquiring the target further includes the step of centering the target in the optical unit.

10. The method of claim 6, wherein the angle between the line of sight and the line defined by the direction of travel of the platform is determined from at least one gimbal angle of the gimbal.

11. The method of claim 6, wherein the speed, the angle, and the rate of change are determined at a single platform position.

12. The method of claim 6, wherein the range is defined as:
r=(v/(dθ/dt))*sin θ.

13. A method of determining a range and geolocation from a platform to a target, comprising the steps of:
(a) providing a platform having a gimbal, an optical unit, a global positioning system (GPS) aided inertial navigation system (INS), and a computing device;
(b) determining a speed of the platform in a direction of travel thereof;
(c) acquiring the target using the optical unit along a line of sight from the platform;
(d) determining an angle between a line defined by the direction of travel of the platform and the line of sight;
(e) determining a rate of change in the angle;
(f) calculating the range based on the speed, the angle, and the rate of change;
(g) determining the geolocation of the platform in space;
(h) determining gimbal angles relative to earth; and
(i) calculating the geolocation of the target based on the geolocation of the platform, gimbal angles relative to earth, and the range.

14. The method of claim 13, and further including the step of providing the speed, the angle, and the rate of change to the computing device.

15. The method of claim 13, and further including the step of providing the geolocation of the platform, the gimbal angles relative to earth, and the range to the computing device.

16. The method of claim 13, wherein the speed, gimbal angles relative to earth, and geolocation of the platform are determined by the global positioning system (GPS) aided inertial navigation system (INS).

17. The method of claim 13, wherein the step of acquiring the target further includes the step of centering the target in the optical unit.

18. The method of claim 13, wherein the optical unit is a telescope.

19. The method of claim 13, wherein the speed, the angle, the rate of change, and the geoposition of the platform are determined at a single platform position.

20. The method of claim 13, wherein the range is defined as:
r=(v/(dθ/dt))*sin θ.

21. The method of claim 13, and further including the step of correlating the range to a topographical map to increase accuracy.
